(19) United States
(12) Patent Application Publication
(10) Pub. No.: US 2026/0257737 A1
(43) Pub. Date: Sep. 3, 2026

(54) DOOR FRAME ASSEMBLY AND ASSEMBLY METHOD THEREOF

(71) Applicants: Hyundai Motor Company, Seoul (KR); Kia Corporation, Seoul (KR)

(72) Inventor: Won Ki Song, Hwaseong-si (KR)

(21) Appl. No.: 19/252,911

(22) Filed: Jun. 27, 2025

(30) Foreign Application Priority Data
Feb. 28, 2025 (KR) 10-2025-0026939

(51) Int. Cl. B62D 33/06; B62D 25/02; B62D 25/06; B62D 27/06; B62D 65/02

(52) U.S. Cl. CPC B62D 33/06; B62D 25/02; B62D 25/06; B62D 27/065; B62D 65/02

(57) ABSTRACT

A door frame assembly can include an outer frame, an assembled frame fixed to the outer frame, and an outer plate coupled to the outer frame and the assembled frame and covering the outer frame and the assembled frame, wherein the outer plate is detachably seated on the assembled frame and fixed to the outer frame.

### CROSS-REFERENCE TO RELATED APPLICATIONS

This application claims benefit of priority to Korean Patent Application No. 10-2025-0026939 filed on Feb. 28, 2025 in the Korean Intellectual Property Office, the disclosure of which is incorporated herein by reference in its entirety.

### TECHNICAL FIELD

The present disclosure relates to a door frame assembly and an assembly method thereof.

### BACKGROUND

There are various types of automobile doors. For example, there are swing type doors mainly applied to passenger cars, sliding type doors mainly applied to mid-sized passenger cars, and hatchback type doors mainly applied to the tailgates of passenger cars and recreational vehicles (RVs).

Meanwhile, purpose-built vehicles (PBVs) have emerged as future mobility vehicles. The possibility of expanding the functions and designs of PBVs according to their purposes is significantly large. PBVs are a new type of mobility vehicles which are neither public transportation, such as buses nor personal passenger cars. Depending on which PBV is docked to a hub, the purpose of the hub itself may change and the hub may be used as a flexible space.

In future automobiles, tailgates may be installed not only at the rear of the vehicle but also on the side, allowing passengers to enter or exit the vehicle from the side, as well as for loading cargo. Among these types of tailgates, a ‘clamshell door,’ which is split in the middle and opens up and down, has come to prominence because it requires less force and takes up less rear space than when opening and closing a large single tailgate.

### SUMMARY

An embodiment of the present disclosure can provide a clamshell door frame assembly and an assembly method thereof, which can be capable of reducing the manufacturing cost.

An embodiment of the present disclosure can provide a clamshell door frame assembly and an assembly method thereof, which can be advantageous for weight reduction.

An embodiment of the present disclosure can provide a clamshell door frame assembly with improved joint rigidity and an assembly method thereof.

According to an embodiment of the present disclosure, a clamshell door frame assembly can include: an outer frame; an assembled frame fixed to the outer frame; and an outer plate coupled to the outer frame and the assembled frame and covering the outer frame and the assembled frame, wherein the outer plate is detachably seated on the assembled frame and fixed to the outer frame.

According to an embodiment of the present disclosure, a method of assembling a clamshell door frame can include: an outer frame preparation operation of preparing an outer frame including a first filler member and a second filler member; an insert frame pre-coupling operation of pre-coupling an insert frame to the first filler member; a center frame manufacturing operation of manufacturing a center frame by coupling a plurality of center frame parts; a first center frame coupling operation of coupling one side of the center frame to the second filler member; a second center frame coupling operation of disposing the center frame such that the other side of the center frame faces the insert frame and then rotating the insert frame so as to be coupled to the other side of the center frame; and an outer plate coupling operation of mounting the side panel and the roof panel on the center frame and then fixing the side panel and the roof panel to the first filler member and the second filler member.

### BRIEF DESCRIPTION OF THE DRAWINGS

The above and other features and advantages of example embodiments of the present disclosure can be more clearly understood from the following detailed description, taken in conjunction with the accompanying drawings, in which:

FIG. 1 is a schematic upper perspective view of a clamshell door frame assembly according to an embodiment of the present disclosure;

FIG. 2 is a schematic lower perspective view of a clamshell door frame assembly according to an embodiment of the present disclosure;

FIG. 3 is a bottom view of a roof panel according to an embodiment of the present disclosure;

FIG. 4 is a side view of a roof panel according to an embodiment of the present disclosure;

FIG. 5 is a front view of a side panel according to an embodiment of the present disclosure;

FIG. 6 is a side view of a side panel according to an embodiment of the present disclosure;

FIG. 7 is a perspective view of an upper portion of a clamshell door frame assembly according to an embodiment of the present disclosure;

FIG. 8 is an exploded perspective view of FIG. 7;

FIG. 9 is a perspective view of a lower portion of a clamshell door frame assembly according to an embodiment of the present disclosure;

FIG. 10 is an exploded perspective view of FIG. 9;

FIG. 11 is a flowchart of a clamshell door frame assembly method according to an embodiment of the present disclosure;

FIG. 12 is a perspective view illustrating a pre-coupling configuration of an insert frame and a first filler member according to an embodiment of the present disclosure;

FIG. 13 is a perspective view illustrating a center frame part according to an embodiment of the present disclosure;

FIG. 14 is a perspective view illustrating a configuration of coupling a center frame to a second filler member according to an embodiment of the present disclosure;

FIG. 15 is a cross-sectional view illustrating a configuration of coupling a center frame to a second filler member according to an embodiment of the present disclosure;

FIG. 16 is a perspective view illustrating a configuration of coupling an insert frame and a center frame according to an embodiment of the present disclosure;

FIG. 17 is a cross-sectional view illustrating a configuration for disposing a center frame opposite to an insert frame to couple the insert frame and the center frame according to an embodiment of the present disclosure;

FIG. 18 is a cross-sectional view illustrating a configuration for coupling an insert frame and a center frame according to an embodiment of the present disclosure;

FIG. 19 is a perspective view illustrating an assembled frame coupled to an outer frame according to an embodiment of the present disclosure; and

FIG. 20 is a perspective view illustrating a configuration for coupling an outer plate to an outer frame according to an embodiment of the present disclosure.

### DETAILED DESCRIPTION OF ILLUSTRATIVE EMBODIMENTS

An embodiment of the present disclosure may be modified in various ways and take on various alternative forms, and specific example embodiments thereof are shown in the drawings and described in detail below. However, it can be understood that there is no intent to necessarily limit the present disclosure to the particular forms disclosed, but on the contrary, the present disclosure can cover modifications, equivalents, and alternatives falling within the spirit and scopes of the present disclosure.

It can be understood that, although the terms “first,” “second,” etc. may be used herein to describe various elements, these elements are not necessarily limited by these terms. These terms can be used merely to distinguish one element from another. For example, a first element could be termed a second element, and a second element could similarly be termed a first element without departing from the scope of the present disclosure. As used herein, the term “and/or” includes any and all combinations of one or more of the associated listed items.

Terms used herein to describe example embodiments of the present disclosure are not intended to necessarily limit the scopes of the present disclosure. The articles “a,” and “an” are singular in that they have a single referent, however the use of the singular form in the present document should not preclude the presence of more than one referent. In other words, elements of the present disclosure referred to in the singular may number one or more, unless the context clearly indicates otherwise. It can be further understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof.

Unless defined in a different way, terms used herein, including technical and scientific terms, can have same meanings as understood by those skilled in the art to which the present disclosure pertains. Terms defined in generally used dictionaries can be construed to have same meanings as those of the contexts of the related art.

In the description below, terms such as “front,” “rear,” “upper,” “lower,” “top,” “bottom,” etc. used in relation to directions are described based on the illustration in the drawing.

Example embodiments of the present disclosure are described in detail with reference to the accompanying drawings.

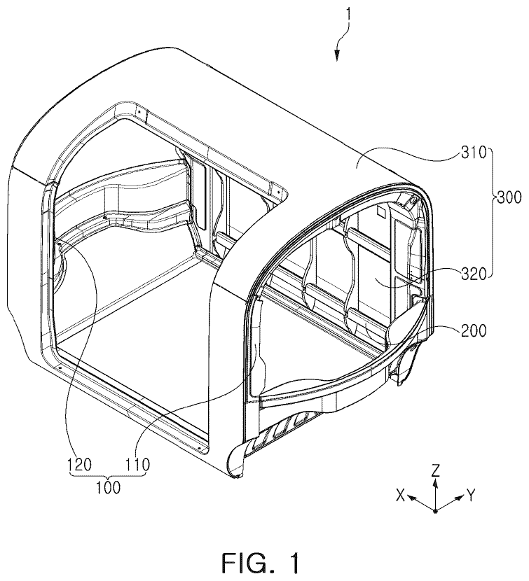

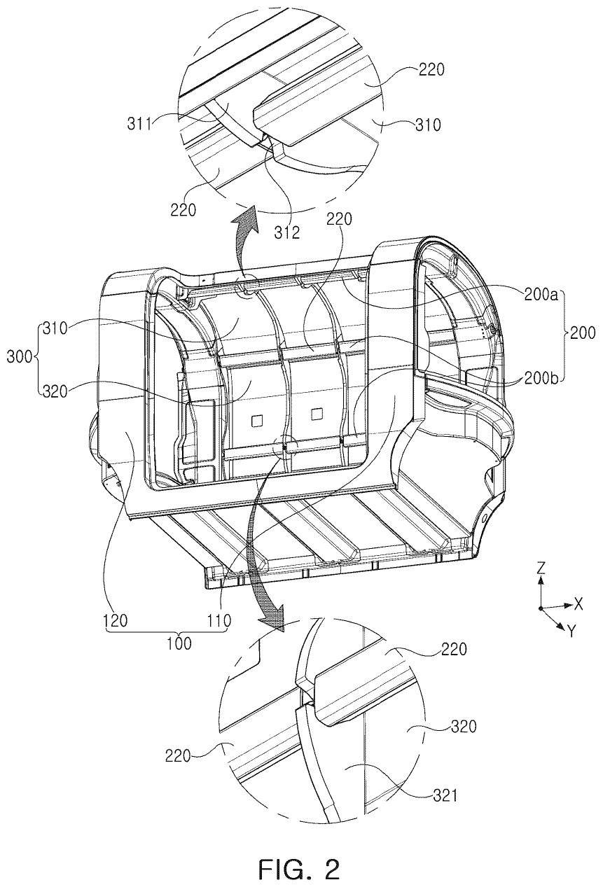

FIG. 1 is a schematic upper perspective view of a clamshell door frame assembly according to an embodiment of the present disclosure. FIG. 2 is a schematic lower perspective view of a clamshell door frame assembly according to an embodiment of the present disclosure.

Referring to FIGS. 1 and 2, a clamshell door frame assembly 1 according to an embodiment of the present disclosure may include an outer frame 100, an assembled frame 200, and an outer plate 300, any of, any combination of, or all of which may be in plural or may include plural components thereof. A clamshell door assembly 1 of an embodiment of the present disclosure can be for a vehicle passenger cabin and/or for a vehicle cargo area, which can be also a modular component for a vehicle body.

The outer frame 100 may constitute a basic skeleton of the clamshell door frame assembly 1. The outer frame 100 may be provided by coupling a plurality of frame modules. The outer frame 100 may include a first filler member 110 and a second filler member 120. The first filler member 110 may be provided on one side of the clamshell door frame assembly 1 in a length direction. The first filler member 110 may be provided in an overall inverted ‘U’ shape. A length direction may refer to the X-axis direction in FIG. 1, a width direction may refer to the Y-axis direction in FIG. 1, and a thickness or height direction may refer to the Z-axis direction in FIG. 1.

The second filler member 120 may be provided to be spaced apart from the first filler member 110. For example, the second filler member 120 may be provided to be spaced apart from the first filler member 110 in the length direction by a set, selected, or predetermined distance. The second filler member 120 may be provided in a shape corresponding to the first filler member 110. For example, the second filler member 120 may be provided in an overall inverted ‘U’ shape. One side of the assembled frame 200 may be fixed to the first filler member 110. The other side of the assembled frame 200 may be fixed to the second filler member.

The first filler member 110 and the second filler member 120 may refer to frames constituting one side and the other side in the length direction of the clamshell door frame assembly 1. The shapes of the first filler member 110 and the second filler member 120 may be variously changed according to structural and design needs or choices. In other words, the first filler member 110 and the second filler member 120 may be changed to various structures as long as they correspond to structures capable of supporting the assembled frame 200, the outer plate 300, etc., which will be described below, on both sides in the length direction.

The assembled frame 200 may be coupled to the outer frame 100. The assembled frame 200 may be coupled to the outer frame 100 at both end portions in the length direction. The assembled frame 200 may form the skeleton of the clamshell door frame assembly 1 together with the outer frame 100. The assembled frame 200 may be disposed in the length direction. For example, the assembled frame 200 may be provided in a rod shape such that both end portions thereof may be connected to the outer frame 100. A plurality of assembled frames 200 may be provided. For example, the assembled frame 200 may include a roof panel support assembled frame 200a provided above the outer frame 100 in the thickness direction to support a roof panel 310 and a side panel support assembled frame 200b provided on one side in the width direction to support a side panel 320. Among the assembled frames 200, the roof panel support assembled frame 200a or the side panel support assembled frame 200b can be disposed in an overlapping portion of the roof panel 310 and the side panel 320 may support the roof panel 310 and the side panel 320 at the same time.

At least one roof panel support assembled frame 200a and at least one side panel support assembled frame 200b may be provided. The roof panel support assembled frame 200a and the side panel support assembled frame 200b may be different only in positions thereof coupled to the outer frame 100 but may have the same configuration. Herein, the roof panel support assembly frame 200a and the side panel support assembly frame 200b can be collectively referred to as the ‘assembly frame 200’.

The outer plate 300 may constitute an outer surface of the clamshell door frame assembly 1. The outer plate 300 may be seated on the assembled frame 200 and coupled to the outer frame 100. For example, both end portions of the outer plate 300 in the length direction may be coupled to the outer frame 100, and a longitudinal inner side of the outer plate 300 may be seated on the assembled frame 200. The outer plate 300 may be detachably seated on the assembled frame 200. The outer plate 300 may be fixed to the outer frame 100.

The outer plate 300 may include a roof panel 310 and a side panel 320. The roof panel 310 may constitute an upper surface of the clamshell door frame assembly 1. For example, the roof panel 310 may be connected to an upper portion of the outer frame 100. The roof panel 310 may have one longitudinal side coupled to the first filler member 110 and the other longitudinal side coupled to the second filler member 120. The roof panel 310 may be seated on the assembled frame 200. The side panel 320 may constitute a side surface of the clamshell door frame assembly 1. For example, the side panel 320 may be coupled to a side portion of the outer frame 100. The side panel 320 may be coupled to the first filler member 110 on one longitudinal side and coupled to the second filler member 120 on the other longitudinal side. The side panel 320 may be mounted on the assembled frame 200.

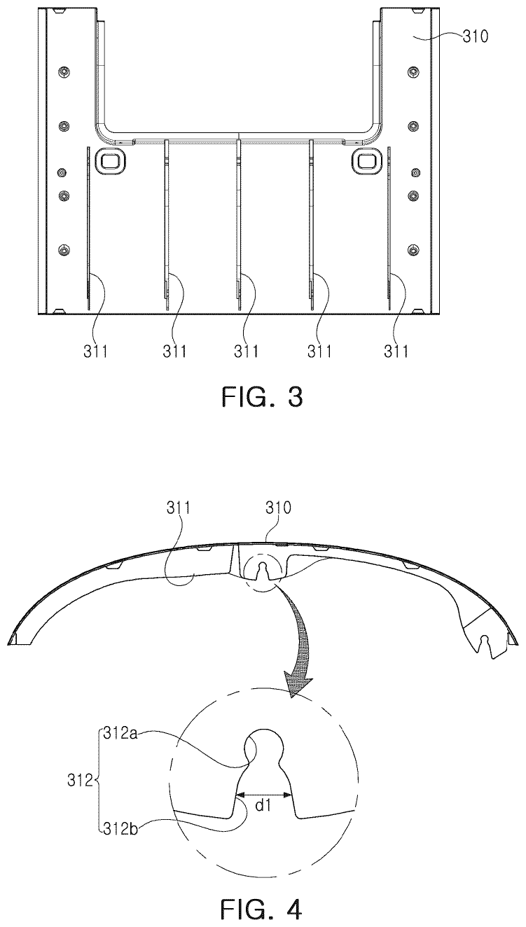

FIG. 3 is a bottom view of a roof panel according to an embodiment of the present disclosure. FIG. 4 is a side view of a roof panel according to an embodiment of the present disclosure.

Referring to FIGS. 3 and 4, the roof panel 310 may include a roof panel rib 311. The roof panel rib 311 may be seated on the assembled frame 200. The roof panel rib 311 may protrude from one surface of the roof panel 310. For example, the roof panel rib 311 may protrude from a bottom surface of the roof panel 310 toward the assembled frame 200. The roof panel rib 311 may be provided in a shape extending in the width direction from the bottom surface of the roof panel 310. The roof panel rib 311 may be provided in plural. For example, the plurality of roof panel ribs 311 may be provided to be spaced apart from each other at a set, selected, or predetermined distance in the length direction. One roof panel rib 311 may be seated on a plurality of assembled frames 200. For example, a roof panel rib 311 may be seated on a plurality of assembled frames 200 arranged in the width direction of the roof panel rib 311. The structure of the roof panel rib 311 may be changed to correspond to the arrangement on the assembled frame 200. In other words, for a roof panel rib 311 corresponding to a component protruding from the bottom surface of the roof panel 310 and seated on the assembled frame 200, the shape of the roof panel rib 311 may be changed variously to a shape commonly used in the art to which the present disclosure pertains.

The roof panel rib 311 may be provided with a roof panel rib recess 312 into which the assembled frame 200 can be inserted. The roof panel rib recess 312 may be provided as an end portion of the roof panel rib 311 and can be recessed inward by a set, selected, or predetermined depth. At least one roof panel rib recess 312 may be provided along the roof panel rib 311. For example, a plurality of roof panel rib recesses 312 may be provided in the width direction of the roof panel rib 311.

The roof panel rib recess 312 may include a section in which a spacing d1 increases from the inner side to the outer side. The roof panel rib recess 312 may include, for example, a first seating part 312a into which the assembled frame 200 can be inserted and in which at least a portion of an inner circumferential surface can be in close contact with the assembled frame 200 and a first insertion part 312b extending outward from one side of the first seating part 312a and having a section in which the spacing d1 increases outward. An inner surface of the first seating part 312a may be provided in a shape corresponding to the outer surface of the assembled frame 200 in contact therewith. For example, the first seating part 312a may be provided in a circular shape with one side open as a hole. The first insertion part 312b may include a section in which the spacing d1 increases toward the open outer side. For example, the first insertion part 312b may be provided in a tapered shape in which the spacing d1 increases toward the open outer side. By providing the first insertion part 312b in a tapered shape, when the roof panel rib 311 is installed on the assembled frame 200, the assembled frame 200 may be easily introduced to the first seating part 312a.

The rigidity of the roof panel 310 may be improved by the roof panel rib 311. Through the roof panel rib 311, a separate rigidity reinforcing member that can be coupled to reinforce the rigidity of the roof panel 310 may be omitted, thereby reducing the weight of the roof panel 310 and reducing the manufacturing cost.

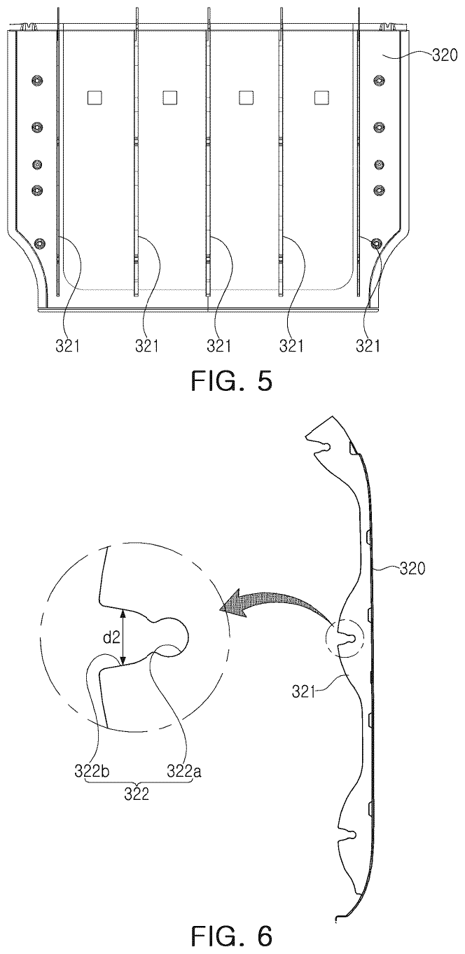

FIG. 5 is a front view of a side panel according to an embodiment of the present disclosure. FIG. 6 is a side view of a side panel according to an embodiment of the present disclosure.

Referring to FIGS. 5 and 6, the side panel 320 may include a side panel rib 321. The side panel rib 321 may be seated on the assembled frame 200. The side panel rib 321 may protrude from one surface of the side panel 320. For example, the side panel rib 321 may protrude from one surface of the side panel 320 toward the assembled frame 200. The side panel rib 321 may be provided in a shape extending from one surface of the side panel 320 in the thickness direction. The side panel rib 321 may be provided in plural. For example, the plurality of side panel ribs 321 may be spaced apart from each other in the length direction. Any one side panel rib 321 may be seated on the plurality of assembled frames 200. For example, the side panel rib 321 may be seated on the plurality of assembled frames 200 arranged in the height direction of the side panel rib 321. The structure of the side panel rib 321 may be changed to correspond to the arrangement on the assembled frame 200. In other words, for a side panel rib 321 corresponding to a component protruding from one surface of the side panel 320 and seated on the assembled frame 200, the shape of the side panel rib 321 may be changed variously.

The side panel rib 321 may be provided with a side panel rib recess 322 into which the assembled frame 200 can be inserted. The side panel rib recess 322 may be provided as the end portion of the side panel rib 321 and can be recessed inwardly by a set, selected, or predetermined depth. At least one side panel rib recess 322 may be provided along the side panel rib 321. For example, a plurality of side panel rib recesses 322 may be provided in the height direction of the side panel rib 321.

The side panel rib recess 322 may include a section in which a spacing d2 increases from the inner side to the outer side of the recess. The side panel rib recess 322 may include, for example, a second seating part 322a into which the assembled frame 200 can be inserted and in which at least a portion of an inner circumferential surface can be in close contact with the assembled frame 200 and a second insertion part 322b extending from one side of the second seating part 322a to the outer side and having a section in which the spacing d2 increases outward. The inner surface of the second seating part 322a may be provided in a shape corresponding to the outer surface of the assembled frame 200 in contact therewith. For example, the second seating part 322a may be provided in a circular shape with one side open as a hole. The second insertion part 322b may include a section in which the spacing d2 increases toward the open outer side of the recess. For example, the second insertion part 322b may be provided in a tapered shape in which the spacing d2 increases toward the open outer side. By providing the second insertion part 322b in a tapered shape, when the side panel rib 321 is seated on the assembled frame 200, the assembled frame 200 may be easily introduced to the second seating part 322a.

The rigidity of the side panel 320 may be improved by the side panel rib 321. Through the side panel rib 321, a separate rigidity reinforcing member that can be coupled to reinforce the rigidity of the side panel 320 may be omitted, thereby reducing the weight of the side panel 320 and reducing the manufacturing cost.

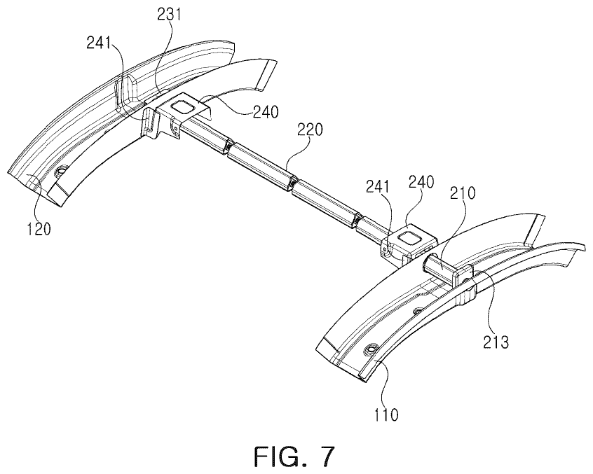

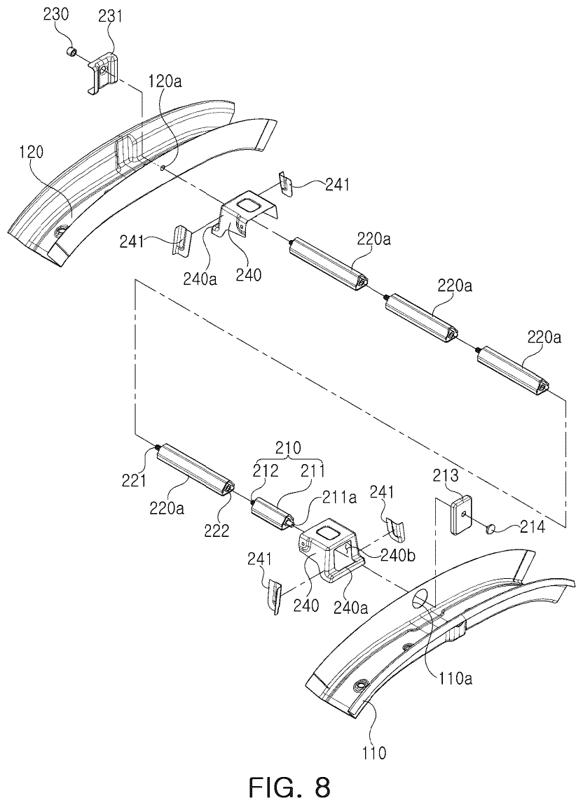

FIG. 7 is a perspective view of the upper portion of a clamshell door frame assembly according to an embodiment of the present disclosure. FIG. 8 is an exploded perspective view of FIG. 7.

The assembled frame 200 illustrated in FIGS. 7 and 8 may correspond to the roof panel support assembled frame 200a. Referring to FIGS. 7 and 8, the assembled frame 200 may be coupled to the upper portion of the outer frame 100. Both longitudinal end portions of the assembled frame 200 may be coupled to the outer frame 100. For example, the assembled frame 200 may have one end portion coupled to the first filler member 110 and the other end portion coupled to the second filler member 120.

The assembled frame 200 may include an insert frame 210 and a center frame 220. The insert frame 210 may be fixed to the first filler member 110. For example, the insert frame 210 may be fixed to the inside of the first filler member 110. The insert frame 210 may include an insert frame body portion 211 having one end portion fixed to the first filler member 110 and an insert frame bolt portion 212 provided on the other side of the insert frame body portion 211. A screw hole 211a may be provided on one side of the insert frame body portion 211. An insert frame fixing panel 213 may be provided on the first filler member 110. The insert frame body portion 211 may be coupled to the insert frame fixing panel 213 on the inside of the first filler member 110 through a fastening member 214, such as a screw. The insert frame 210 may be connected with the center frame 220 through an insert frame connection hole 110a provided in the first filler member 110.

The insert frame bolt portion 212 may be coupled to the center frame 220. For example, the insert frame bolt portion 212 may be coupled to the center frame part 220a constituting the center frame 220 by penetrating through the insert frame connection hole 110a. A nut portion 222 that may be screw-coupled with the insert frame bolt portion 212 may be provided at an end portion of the center frame part 220a. The insert frame bolt portion 212 may be screw-coupled to the nut portion 222 of the center frame part 220a. The insert frame bolt portion 212 and the bolt portion 221 provided in the center frame part 220a may be provided with the same screw specifications. In other words, both the insert frame bolt portion 212 and the bolt portion 221 may be screw-coupled to the nut portion 222 of the center frame part 220a.

One side of the center frame 220 may be coupled to the second filler member 120. The other side of the center frame 220 may be coupled to the insert frame 210. A pipe nut 230 for coupling with the center frame 220 may be provided inside the second filler member 120. The center frame 220 may be provided by coupling a plurality of center frame parts 220a in one direction. For example, the center frame 220 may be provided by coupling a plurality of center frame parts 220a in the length direction. The bolt portion 221 may be provided at one end portion of the center frame part 220a. The nut portion 222 may be provided at the other end portion of the center frame part 220a. The bolt portion 221 may be screw-coupled to the nut portion 222 of the adjacently disposed center frame part 220a.

The bolt portion 221 of any one center frame part 220a disposed adjacent to the second filler member 120 among the center frame parts 220a may be coupled to the second filler member 120. For example, the bolt portion 221 of any one center frame part 220a disposed adjacent to the second filler member 120 may pass through a fastening hole 120a provided in the second filler member 120 and be coupled to the pipe nut 230 provided inside the second filler member 120.

The insert frame bolt portion 212 of the insert frame 210 may be screw-coupled to the nut portion 222 of one of the center frame parts 220a disposed adjacent to the insert frame 210.

The pipe nut 230 and a pipe nut support 231 may be provided to secure the center frame 220 to the outer frame 100 and distribute a load transmitted to the outer frame 100 by the center frame 220. The center frame part 220a of the center frame 220 may be screw-coupled to the pipe nut 230 by penetrating through the fastening hole 120a formed in the outer frame 100.

An upper door mounting bracket 240 may be coupled to the outer frame 100. For example, the upper door mounting bracket 240 may be coupled to upper portions of the first filler member 110 and the second filler member 120. The upper door mounting bracket 240 may be provided to connect a clamshell door (not shown) coupled to the clamshell door frame assembly 1. A separate upper door hinge (not shown) may be coupled to the upper door mounting bracket 240. At least a portion of the upper door mounting bracket 240 may be welded to the outer frame 100 or may be coupled using a separate fastening device, such as a screw. The upper door mounting bracket 240 may be coupled to the inner side parts of the first filler member 110 and the second filler member 120 provided on both sides in the length direction, respectively. A lower portion 240a of one surface of the upper door mounting bracket 240 facing the outer frame 100 may protrude and be bent toward the outer frame 100. Accordingly, a space may be provided between the upper door mounting bracket 240 and the outer frame 100. A roof panel rib 311 may be inserted into the space and may be seated on the assembled frame 200. At least a portion of the protruded and bent lower portion 240a of the upper door mounting bracket 240 may be welded to the inner side of the outer frame 100. The upper door mounting bracket 240 may be provided with a through-hole 240b through which the assembled frame 200 can pass in the length direction. The assembled frame 200 may be coupled to an inner side part of the outer frame 100 by penetrating through the through-hole 240b.

A support flange 241 may be provided to support the upper door mounting bracket 240 and distribute the load transmitted to the upper door mounting bracket 240 to the outer frame 100. The support flange 241 may be provided on one surface of the outer frame 100 facing the upper door mounting bracket 240. The support flange 241 may be coupled to the outer frame 100 by welding or screwing. The support flange 241 may be in contact with both outer surfaces of the upper door mounting bracket 240 in the width direction to support the upper door mounting bracket 240. A portion of the support flange 241 not in contact with the upper door mounting bracket 240 may be bent and coupled to the outer frame 100. For example, the support flange 241 may be provided with a thickness-direction cross-section in an ‘L’ shape. The support flange 241 may be provided in pairs. In other words, the support flange 241 may be provided as a pair spaced apart from an inner surface of the outer frame 100 by a set, selected, or predetermined distance. The inner surfaces of the pair of support flanges 241 may support one outer surface and the other outer surface of the upper door mounting bracket 240 in the width direction, respectively. The load transmitted to the upper door mounting bracket 240 may be distributed through the lower portion 240a of the upper door mounting bracket 240 and the support flange 241 and transmitted to the outer frame 100. Due to this load distribution, the structural stability of the clamshell door frame assembly 1 may be improved.

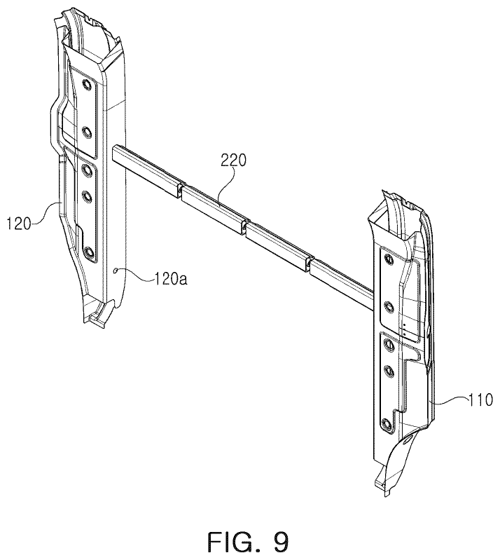

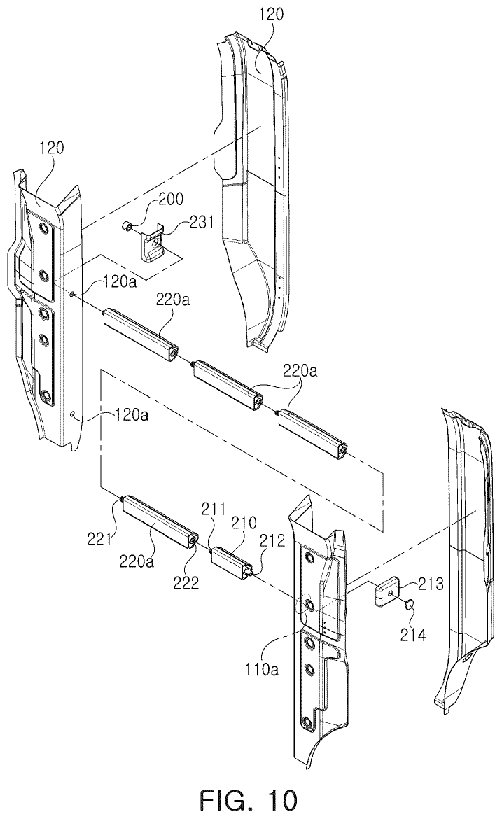

Referring to FIGS. 9 and 10, the assembled frame 200 may be coupled to a side portion of the outer frame 100. The assembled frame 200 illustrated in FIGS. 9 and 10 may correspond to the side panel support assembled frame 200b. At least one assembled frame 200 may be provided in the height direction on the side portion of the outer frame 100, for example. Both end portions of the assembled frame 200 in the length direction may be coupled to the outer frame 100. For example, one end portion of the assembled frame 200 may be coupled to the first filler member 110 and the other end portion thereof may be coupled to the second filler member 120. As described above, the configurations of the roof panel support assembled frame 200a and the side panel support assembled frame 200b can be substantially the same. Therefore, a detailed description of such configuration will be omitted.

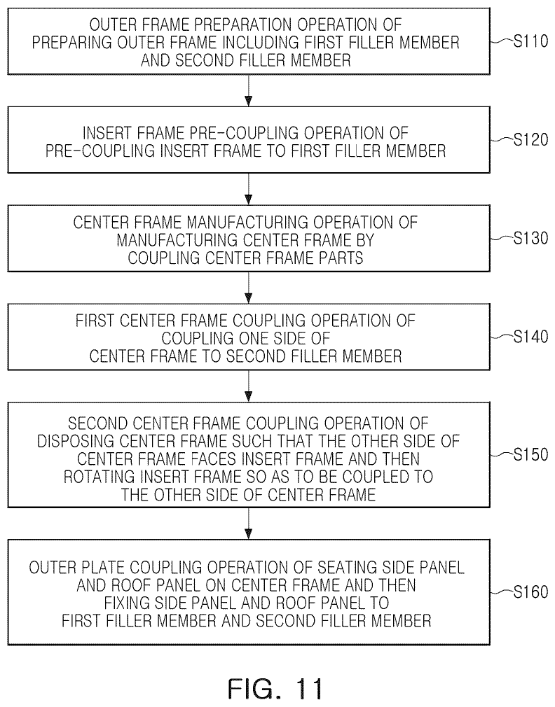

FIG. 11 is a flowchart of a method of assembling a clamshell door frame according to an embodiment of the present disclosure.

A method of assembling a clamshell door frame according to an embodiment of the present disclosure may include an outer frame preparation operation (operation S110), an insert frame pre-coupling operation (operation S120), a center frame manufacturing operation (operation S130), a first center frame coupling operation (operation S140), a second center frame coupling operation (operation S150), and an outer plate coupling operation (operation S160).

First, the outer frame preparation operation (operation S110) of preparing the outer frame 100 may be performed. The outer frame 100 may constitute a basic skeleton of the clamshell door frame assembly 1. The outer frame 100 may be provided by coupling a plurality of frame modules. For example, the outer frame 100 may include the first filler member 110 arranged on one side in the length direction and the second filler member 120 provided to be spaced apart from the first filler member 110 by a set, selected, or predetermined distance in the length direction. The first filler member 110 may be provided in an overall inverted ‘U’ shape. The second filler member 120 may be provided in a shape corresponding to the first filler member 110. As an example, the second filler member 120 may be provided in an overall inverted ‘U’ shape. One side of the assembled frame 200 may be fixed to the first filler member 110. The other side of the assembled frame 200 may be fixed to the second filler member.

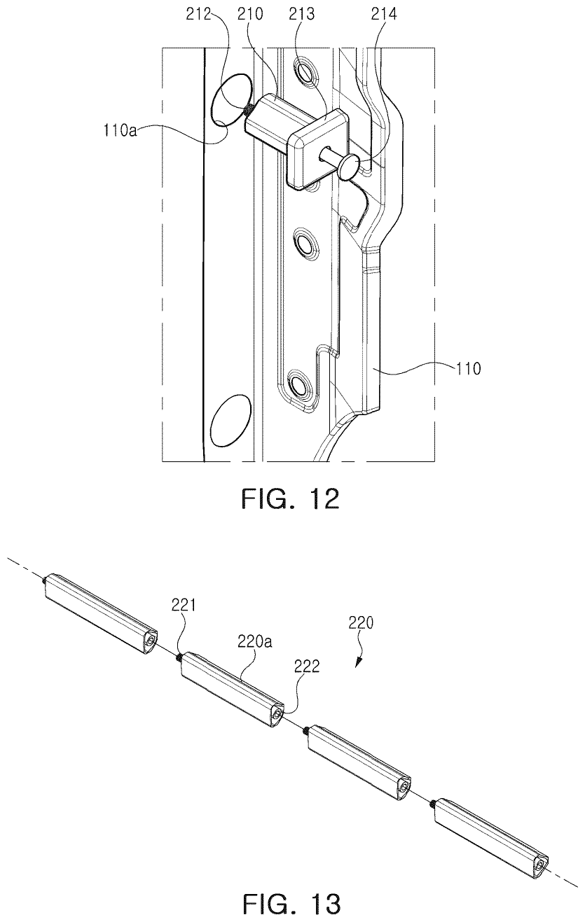

Next, referring to FIG. 12, the insert frame pre-coupling operation (operation S120) may be performed. The insert frame 210 may include the insert frame body portion 211 and an insert frame bolt portion 212 protruding from an end portion of the insert frame body portion 211. In the insert frame pre-coupling operation (operation S120), the insert frame 210 may be disposed inside the first filler member 110. The insert frame 210 may be pre-coupled to the insert frame fixing panel 213 inside the first filler member 110. A screw hole (211a, see FIG. 17) may be provided on one side of the insert frame body portion 211. By screwing the fastening member 214, such as a screw, into the screw hole 211a of the insert frame 210 through the insert frame fixing panel 213, the insert frame 210 may be pre-coupled to the insert frame fixing panel 213 inside the first filler member 110. The pre-coupling may refer to a state in which the insert frame 210 is temporarily fixed to the insert frame fixing panel 213. In the pre-coupling state, the insert frame 210 may be disposed inside the first filler member 110, and thus may not interfere when the assembled frame 200 is coupled (see FIG. 15). However, in the pre-coupling state of the insert frame 210, a portion of the insert frame 210 may protrude outside the first filler member 110 as long as it does not interfere with the movement and arrangement of the assembled frame 200.

Next, referring to FIG. 13, the center frame manufacturing operation (operation S130) may be performed. However, the center frame 220 manufacturing operation (operation S130) may be performed regardless of the order of the outer frame preparation operation (operation S110) and the insert frame pre-coupling operation (operation S120). In other words, the center frame manufacturing operation (operation S130) may be performed regardless of the order as long as it is before the first center frame coupling operation (operation S140).

The center frame 220 may be provided by coupling a plurality of center frame parts 220a in one direction. For example, the center frame 220 may be provided by coupling a plurality of center frame parts 220a in the length direction. The bolt portion 221 may be provided at one end portion of the center frame part 220a. The nut portion 222 may be provided at the other end portion of the center frame part 220a. The bolt portion 221 may be screw-coupled to the nut portion 222 of the adjacently disposed center frame part 220a.

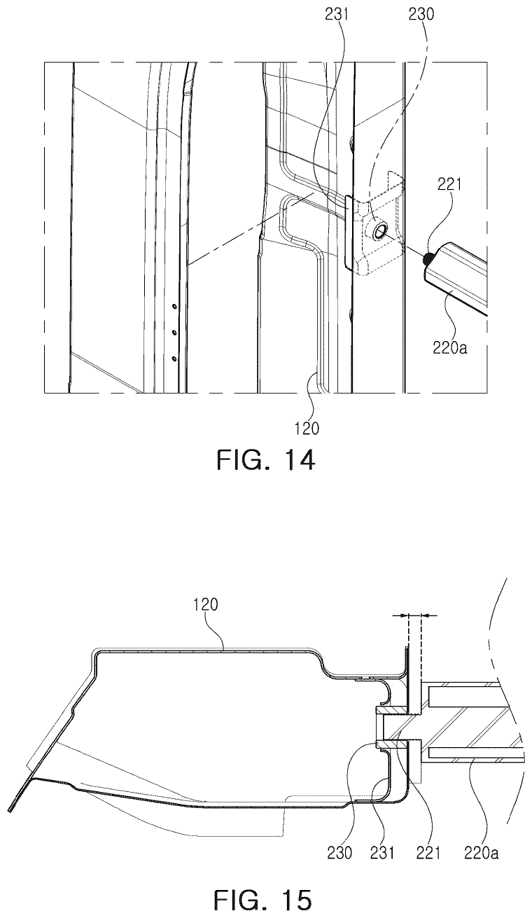

Next, referring to FIGS. 14 and 15, the first center frame coupling operation (operation S140) may be performed. In the first center frame coupling operation (operation S140), one side of the center frame 220 may be coupled to the second filler member 120.

The bolt portion 221 of any one center frame part 220a disposed adjacent to the second filler member 120 among the center frame parts 220a may be coupled to the second filler member 120. For example, the bolt portion 221 of one center frame part 220a disposed adjacent to the second filler member 120 may pass through the fastening hole 120a provided in the second filler member 120 and be coupled to the pipe nut 230 provided inside the second filler member 120. The insert frame 210 may be disposed inside the first filler member 110 so as not to interfere with coupling the center frame 220 to the second filler member 120.

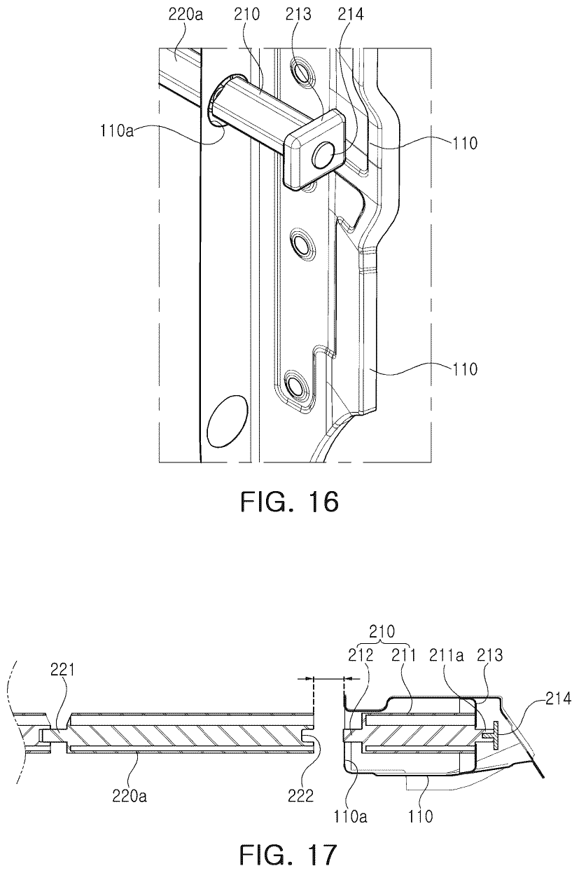

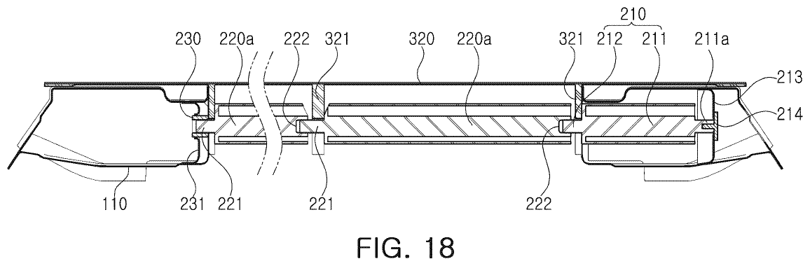

Thereafter, referring to FIG. 16, the second center frame coupling operation (operation S150) may be performed. In the second center frame coupling operation (operation S150), the center frame 220 and the insert frame 210 may be coupled. The insert frame bolt portion 212 of the insert frame 210 may be screw-coupled to the nut portion 222 of one of the center frame parts 220a disposed adjacent to the insert frame 210. In a state in which one end portion of the center frame 220 is fixed to the second filler member 120, the other end portion of the center frame 220 may be disposed to face the insert frame 210 (see FIG. 17). When the other end portion of the center frame 220 is disposed to face the insert frame 210, the insert frame 210 may be slidably moved toward the center frame 220 and the fastening member 214 may be rotated. When the fastening member 214 rotates, the insert frame 210 may be rotated and the insert frame bolt portion 212 of the insert frame 210 may be screw-coupled to the nut portion 222 of the center frame part 220a (see FIG. 18).

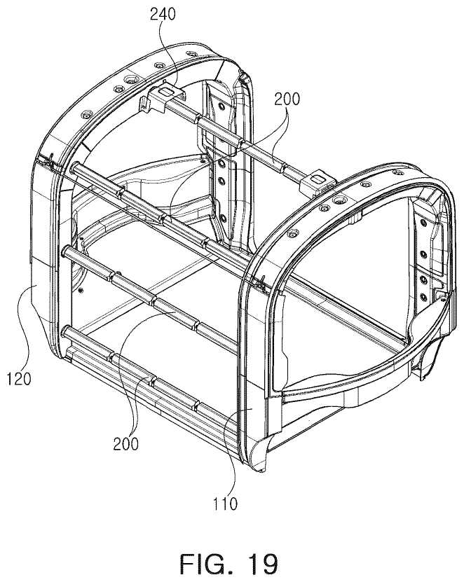

The insert frame pre-coupling operation (operation S120), the center frame manufacturing operation (operation S130), the first center frame coupling operation (operation S140), and the second center frame coupling operation (operation S150) may be performed a plurality of times to correspond to the number of assembled frames 200 provided in the outer frame 100. For example, FIG. 19 illustrates a configuration in which four assembled frames 200 are coupled to the outer frame 100.

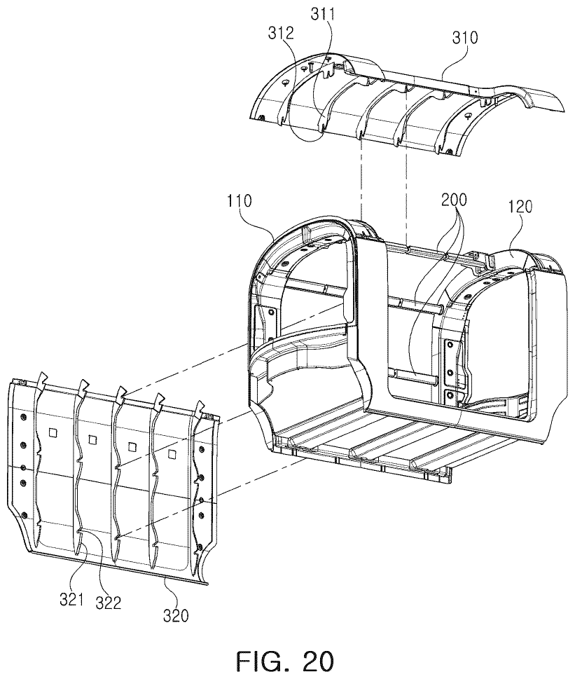

Referring to FIG. 20, after assembling all the assembled frames 200 to the outer frame 100, the outer plate coupling operation (operation S160) may be performed. In the outer plate coupling operation (operation S160), the side panel 320 and the roof panel 310 may be seated on the center frame 220, and then the side panel 320 and the roof panel 310 may be fixed to the first filler member 110 and the second filler member 120.

In the method of assembling a clamshell door frame assembly according to another embodiment of the present disclosure, the center frame parts may be coupled using a bolt/nut shape and the outer plate and the assembled frame may be coupled through the rib structure of the outer plate. Therefore, the assembly process may be simplified, thereby shortening the manufacturing time and reducing the manufacturing cost.

A clamshell door frame assembly and an assembly method thereof according to an embodiment of the present disclosure may reduce the manufacturing cost.

A clamshell door frame assembly and an assembly method thereof according to an embodiment of the present disclosure may be advantageous in weight reduction.

A clamshell door frame assembly and an assembly method thereof according to an embodiment of the present disclosure may improve the joint rigidity.

While example embodiments have been shown and described above, it can be apparent to those skilled in the art that modifications and variations can be made without departing from the scopes of the present disclosure as defined by the appended claims and equivalents thereof.

What is claimed is:

1. A door frame assembly comprising:
an outer frame;
an assembled frame fixed to the outer frame; and
an outer plate coupled to the outer frame and the assembled frame and covering the outer frame and the assembled frame, wherein the outer plate is detachably seated on the assembled frame and fixed to the outer frame.

2. The assembly of claim 1, wherein the outer plate comprises:
a roof panel connected to an upper portion of the outer frame and seated on the assembled frame; and
a side panel connected to a side portion of the outer frame and seated on the assembled frame.

3. The assembly of claim 2, wherein the roof panel includes a roof panel rib protruding toward the assembled frame, and the roof panel rib is seated on the assembled frame.

4. The assembly of claim 3, wherein the roof panel rib includes a roof panel rib recess into which the assembled frame is inserted.

5. The assembly of claim 4, wherein the roof panel rib recess includes a rib recess section in which a spacing of the rib recess section increases from a recess inside to a recess outside.

6. The assembly of claim 4, wherein the roof panel rib recess comprises:
a first seating part into which the assembled frame is inserted and in which at least part of an inner circumferential surface of the first seating part is in contact with the assembled frame; and
a first insertion part having a rib recess section extending outward from the first seating part and having a spacing increasing outwardly.

7. The assembly of claim 2, wherein the side panel includes a side panel rib protruding toward the assembled frame, and the side panel rib is seated on the assembled frame.

8. The assembly of claim 7, wherein the side panel rib includes a side panel rib recess into which the assembled frame is inserted.

9. The assembly of claim 8, wherein the side panel rib recess includes a rib recess section in which a spacing of the rib recess section increases from a recess inside to a recess outside.

10. The assembly of claim 8, wherein the side panel rib recess comprises:
a second seating part into which the assembled frame is inserted and in which at least part of an inner circumferential surface of the second seating part is in contact with the assembled frame; and
a second insertion part having a rib recess section extending outward from the second seating part and having a spacing increasing outwardly.

11. The assembly of claim 1, wherein the outer frame comprises:
a first filler member to which a first side of the assembled frame is fixed; and
a second filler member spaced apart from the first filler member and to which a second side of the assembled frame is fixed.

12. The assembly of claim 11, wherein the assembled frame comprises:
an insert frame fixed to the first filler member; and
a center frame having a first center-frame side connected to the insert frame and a second center-frame side fixed to the second filler member, wherein the center frame includes a plurality of center frame parts coupled together.

13. The assembly of claim 12, wherein the insert frame comprises:
an insert frame body portion having a first insert-frame end portion fixed to the first filler member; and
an insert frame bolt portion protruding from a second insert-frame end portion of the insert frame body portion and coupled to a first center frame part of the plurality of center frame parts.

14. The assembly of claim 12, wherein each of the plurality of center frame parts comprises:
a bolt portion at a first center-frame-part end portion; and
a nut portion screw-coupled to the bolt portion at a second center-frame-part end portion.

15. The assembly of claim 12, further comprising a pipe nut coupling the center frame to the second filler member.

16. A method of assembling a door frame assembly, the method comprising:
providing an outer frame including a first filler member and a second filler member;
coupling an insert frame to the first filler member;
manufacturing a center frame by coupling a plurality of center frame parts;
coupling a first center-frame side of the center frame to the second filler member;
placing the center frame such that a second center-frame side of the center frame faces the insert frame;
rotating the insert frame to couple the insert frame to the second center-frame side of the center frame;
mounting a side panel and a roof panel on the center frame; and
fixing the side panel and the roof panel to the first filler member and the second filler member.

17. The method of claim 16, wherein the insert frame comprises:
an insert frame body portion having a first insert-frame end portion fixed to the first filler member, and
an insert frame bolt portion protruding from a second insert-frame end portion of the insert frame body portion; and
wherein the coupling of the insert frame to the first filler member comprises placing the insert frame inside the first filler member; and
wherein the placing of the center frame and the rotating of the insert frame to couple the insert frame to the second center-frame side of the center frame comprise:
moving the insert frame toward the center frame,
penetrating at least part of the insert frame bolt portion through the first filler member, and
coupling the insert frame to the second center-frame side of the center frame disposed outside the first filler member.

18. The method of claim 16, wherein the coupling of the insert frame to the first filler member comprises:
placing the insert frame inside the first filler member; and
coupling the insert frame with an insert frame fixing bolt.

19. The method of claim 16, wherein the roof panel includes a roof panel rib seated on the center frame, and wherein the side panel includes a side panel rib seated on the center frame.

20. The method of claim 19, wherein the roof panel rib includes a roof panel rib recess at a roof-panel-rib end portion of the roof panel rib, wherein the side panel rib includes a side panel rib recess at a side-panel-rib end portion of the side panel rib, and wherein each of the roof panel rib recess and the side panel rib recess includes a recess section in which a spacing increases outwardly.
